(19) United States
(12) Patent Application Publication
(10) Pub. No.: US 2019/0332578 A1
(43) Pub. Date: Oct. 31, 2019

(54) DOCUMENT MANAGEMENT APPARATUS AND NON-TRANSITORY COMPUTER READABLE MEDIUM

(71) Applicant: FUJI XEROX CO., LTD, Tokyo (JP)

(72) Inventor: Yuji KAZAMA, Kanagawa (JP)

(73) Assignee: FUJI XEROX CO., LTD, Tokyo (JP)

(21) Appl. No.: 16/387,088

(22) Filed: Apr. 17, 2019

(30) Foreign Application Priority Data
Apr. 27, 2018 (JP) 2018-087007
Apr. 27, 2018 (JP) 2018-087009

(51) Int. Cl. G06F 16/176; G10L 15/26; G06F 17/24

(52) U.S. Cl. CPC G06F 16/176; G06F 17/241; G10L 15/26

(57) ABSTRACT

There is provided a document management apparatus a display controller configured to display a screen on a display of the first terminal device according to a predetermined condition. The screen allowing an input of additional information to an edit made from the first terminal device to the document. The document management apparatus allows operators of plural terminal devices, including the first terminal device, connected to the document management apparatus to collaboratively edit a document.

### CROSS-REFERENCE TO RELATED APPLICATIONS

This application is based on and claims priority under 35 USC 119 from Japanese Patent Application No. 2018-087007 and Japanese Patent Application No. 2018-087009 filed Apr. 27, 2018.

### BACKGROUND

### (i) Technical Field

The present disclosure relates o a document management apparatus and a non-transitory computer readable medium.

### (ii) Related Art

Recently, a document management apparatus has been proposed to allow plural persons to work on a single document and share content that changes from moment to moment (see, for example, JP-A-2010-152694).

The document management apparatus disclosed in JP-A-2010-152694 includes: a bulletin board unit including an information acquisition unit for acquiring an article which is a content of consultation or discussion by a user and information representing a thread having a response relationship to the article; a document unit including a presenting unit for presenting the thread for browsing by plural users and an editing unit for supporting editing of the document based on the thread; a database unit storing, based on registration of the information, deletion of the information, change of the information, and extraction of the information associated with the consultation or discussion, the corresponding information, in the bulletin board unit and the document unit; and an input/output terminal device for performing input/output of the information.

### SUMMARY

Aspects of non-limiting embodiments of the present disclosure relate to a document management apparatus and a non-transitory computer readable medium capable of prompting an editor concerned to enter additional information to an edit made to a document according to a predetermined condition in accordance with a connection state of collaborative editors of the document.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, a document management apparatus allowing operators of plural terminal devices connected to the document management apparatus to collaboratively edit a document includes a display controller configured to display a screen on a display of a first terminal device according to a predetermined condition. The screen allows an input of additional information to an edit made from the first terminal device to the document. The predetermined condition is related to one or more terminal devices connected to the document management apparatus other than the first terminal device.

### BRIEF DESCRIPTION OF THE DRAWINGS

Exemplary embodiment(s) of the present disclosure will be described in detail based on the following figures, wherein:

FIG. 1 is a block diagram illustrating an example of a control system of a document management system according to a first exemplary embodiment of the present disclosure;

FIG. 2A is a diagram illustrating an example of a terminal device table;

FIG. 2B is a diagram for schematically describing a connection state illustrated in FIG. 2A;

FIG. 3 is a diagram illustrating an example of a document information table;

FIG. 4 is a diagram illustrating an example of an additional information table;

FIG. 5 is a diagram illustrating an example of an additional information input screen;

FIG. 6 is a diagram illustrating an example of a pop-up window;

FIGS. 7A and 7B are diagrams illustrating examples of the terminal device table. FIG. 7A is a diagram illustrating an example of the terminal device table in accordance with a second connection state, and FIG. 7B is a diagram illustrating an example of the terminal device table in accordance with a third connection state;

FIG. 8 is a diagram illustrating an example of a control system of a terminal device;

FIG. 9 is a flowchart illustrating an example of an operation of the document management apparatus illustrated in FIG. 1;

FIG. 10 is a diagram illustrating a modification of the terminal device table;

FIG. 11 is a block diagram illustrating an example of a control system of a document management system according to a second exemplary embodiment of the present disclosure;

FIG. 12 is a diagram illustrating an example of a terminal device table;

FIG. 13 is a diagram illustrating an example of a keyword table;

FIG. 14A is a diagram illustrating an example of a related information table;

FIG. 14B is a diagram illustrating an example of an additional information table;

FIG. 15 is a diagram illustrating an example of an additional information input screen;

FIG. 16 is a diagram illustrating an example of a control system of a terminal device;

FIG. 17 is a flowchart illustrating an example of an operation of a document management apparatus illustrated in FIG. 11;

FIG. 18 is a diagram illustrating an example of a pop-up window;

FIG. 19 is a block diagram illustrating an example of a control system of a document management system according to a third exemplary embodiment of the present disclosure;

FIG. 20 is a diagram illustrating an example of a second keyword table; and

FIG. 21 is a flowchart illustrating an example of an operation of a document management apparatus illustrated in FIG. 19.

### DETAILED DESCRIPTION

Hereinafter, exemplary embodiments of the present disclosure will be described with reference to the accompanying drawings. Throughout the drawings, elements having substantially the same functions are denoted by the same reference numerals and duplicated description thereon will be omitted.

### Summary of Exemplary Embodiments

A document management apparatus according to exemplary embodiments includes a display controller configured to display a screen on a display of the first terminal device according to a predetermined condition. The screen allowing an input of additional information to an edit made from the first terminal device to the document. The document management apparatus allows operators of plural terminal devices, including the first terminal device, connected to the document management apparatus to collaboratively edit a document.

The phrase “a terminal device is connected to the document management apparatus” refers to a state in which a document on the document management apparatus is editable by operating the terminal device.

### First Exemplary Embodiment

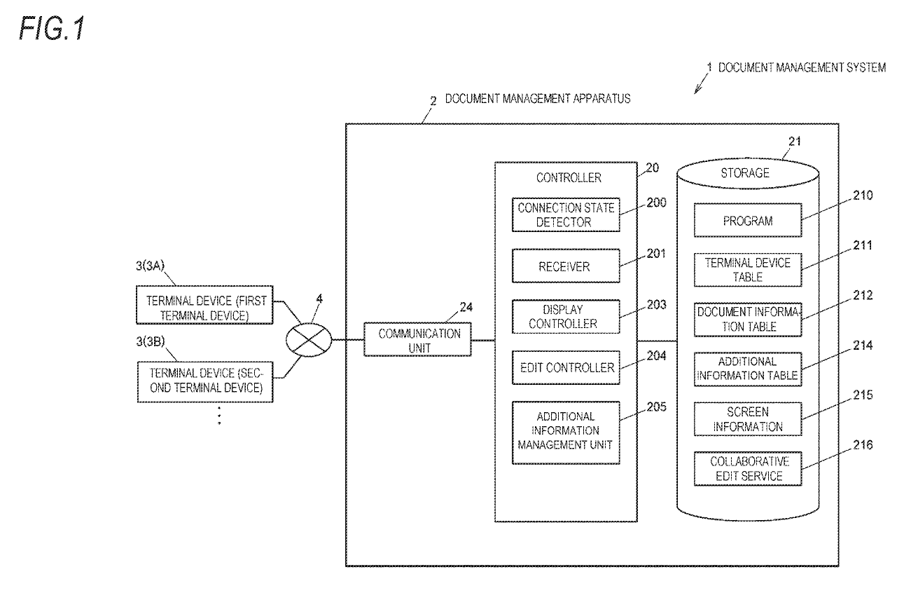

FIG. 1 is a diagram illustrating an example of the configuration of a document management system according to a first exemplary embodiment of the present disclosure. The document management system 1 includes a document management apparatus 2, plural terminal devices 3, and a network 4. The network 4 allows the document management apparatus 2 and the plural terminal devices 3 to communicate with each other. The document management apparatus 2 is, for example, a server apparatus (may be a cloud server apparatus).

As the terminal device 3, for example, a personal computer, a tablet terminal, or a multifunctional mobile phone (smart phone) may be used. Alternatively, the terminal device 3 may be a web browser.

The terminal devices 3 may be used to, for example, edit a document on the document management apparatus 2. Persons who operate the terminal devices 3 may be collectively referred to as operators “users”). The operators include a first operator (also referred to as an “editor”) who is editing a document from one of the plural terminal devices 3 and a second operator (also referred to as a “collaborator”) who is viewing the document at another one of the plural terminal devices 3. The operators may be participants in a discussion where a document managed by the document management apparatus 2 is edited.

In the following description, when it is necessary to distinguish the terminal device 3 operated by the first operator (editor) who is editing a document and the other terminal device(s) 3, the terminal device 3 operated by the editor may be referred to as a “first terminal device 3A” and the other terminal device(s) 3 may be referred to as “second terminal device(s) 3B”. The plural terminal devices may include one or more second terminal devices 3B.

The network 4 may be, for example, a local area network (LAN), a wide area network (WAN), the Internet, or Intranet and may be a wired network or a wireless network.

### (Configuration of Document Management Apparatus 2)

The document management apparatus 2 includes a controller 20, a storage 21 that stores various data, and a communication unit 24 that communicates with the terminal devices 3 via the network 4.

The controller 20 includes, for example, a central processing unit (CPU) and an interface. The CPU operates in accordance with a program 210 stored in the storage 21, to thereby function as, for example, a connection state detector 200, a receiver 201, a display controller 203, an edit controller 204, and an additional information management unit 205. The edit controller 204 is an example of an edit unit. Details of each unit will be described later.

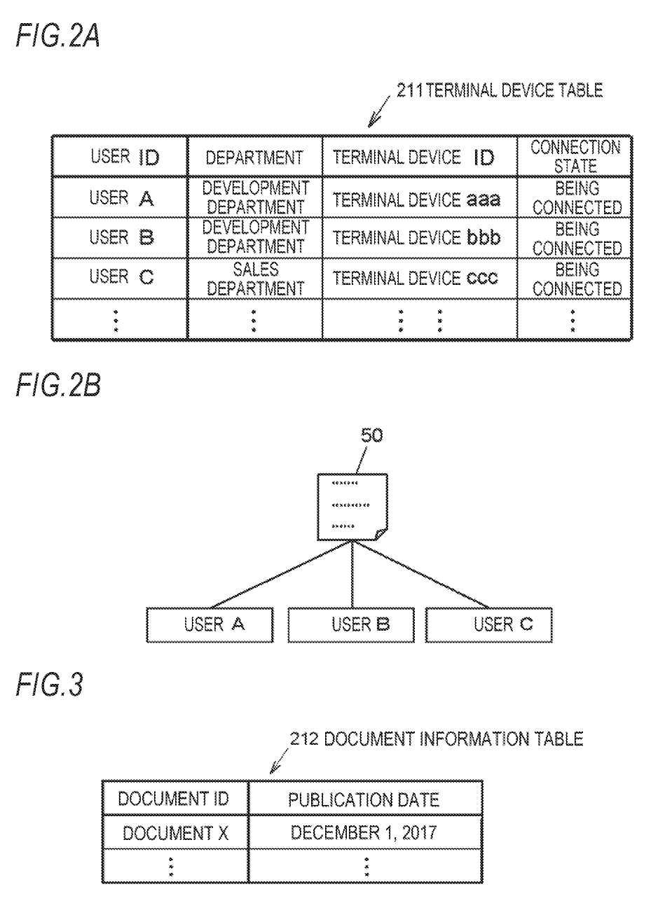

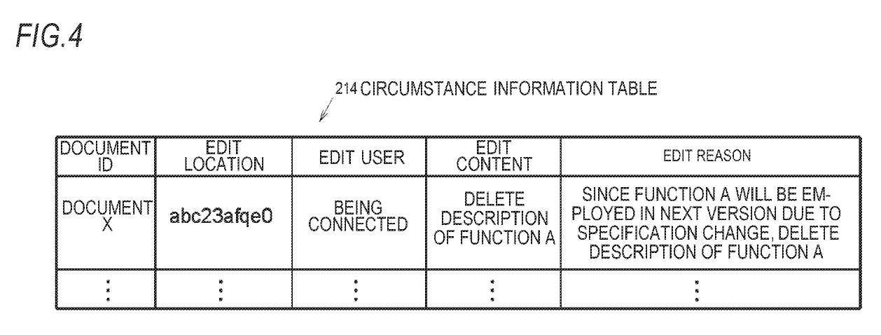

The storage 21 is implemented by a read only memory (ROM), a random access memory (RAM), or a hard disk. The storage 21 stores various data such as the program 210, a terminal device table 211 (see FIG. 2A), a document information table 212 (see FIG. 3), a additional information table 214 (see FIG. 4), screen information 215, and a collaborative edit service 216. The storage 21 is an example of a storage.

### (Configuration of Terminal Device Table 211)

FIG. 2A is a diagram illustrating an example of the terminal device table 211. Information indicating whether each terminal device 3 is connected to the document management apparatus 2 and identification information of the operator of each terminal device 3 are recorded in the terminal device table 211. It should be noted that in this specification, when information is written into a table, the term “record” is used and that when information is written into the storage 21, the term “store” is used.

The terminal device table 211 may have, for example, a “user ID” column, a “department” column, a “terminal device ID” column, and a “connection state” column. In the “user ID” column, identification information of the operator is recorded. In the “department” column, a name of a department to which the operator belongs is recorded. The department is an example of an organization to which the operator belongs. The “organization” refers to a group of people. Examples of the organization include departments of a company, teams and groups of a department, and other associations. Other attributes of the operator than the department may also be recorded in association with the user ID of the operator. Examples of an attribute include an employee number, a duty, a position, and an authority of an operation.

In the “terminal device ID” column, identification information of the terminal device 3 is recorded. Instead of the ID, for example, an IP address may be recorded. In the “connection state” column, whether the terminal device 3 is connected to the document management apparatus 2 or not is recorded. For example, “connected” indicates that the terminal device 3 is connected to the document management apparatus 2 and “unconnected” indicates that the terminal device 3 is not connected to the document management apparatus 2.

Here, the phrase “the terminal device 3 is connected to the document management apparatus 2” refers to a state in which a document is editable on the document management apparatus 2 by operating the terminal device 3. The term “connected (connect, connection)” includes, for example, a state in which the collaborative edit service 216 is available to the terminal device 3. Details of the collaborative edit service 216 will be described later.

FIG. 2B is a diagram for schematically describing a connection state illustrated in FIG. 2A. When terminal devices 3 (a “terminal device aaa”, a “terminal device bbb”, and a “terminal device ccc”) associated with three operators (a “user A”, a “user B”, and a “user C”) are connected to the document management apparatus 2 as illustrated in FIG. 2A, the three operators may collaboratively edit a document 50 as illustrated in FIG. 2B.

The phrase “collaboratively edit a document” refers to editing the same document by plural operators. In other words, the phrase “collaboratively edit a document” refers to that plural terminal devices 3 are connected to the document management apparatus 2. Further, hereinafter, a case where a document is being collaboratively edited may be referred to as “under collaborative editing”.

### (Document Information Table 212)

FIG. 3 is a diagram illustrating an example of the document information table 212. In the document information table 212, information indicating an attribute of the document stored in the storage 21 is recorded. The document information table 212 includes, for example, a “document ID” column in which identification information of the document is recorded and a column indicating the attribute of the document. In this exemplary embodiment, as illustrated in FIG. 3, a “publication date” column is provided in which a date (hereinafter, simply referred to as a “publication date”) on which the document is made public is recorded. The “publication date” is an example of the attribute of the document.

The publication date refers to a date on which the document is disclosed to unspecified or many persons. Examples of the publication date include a date on which restriction on an authority to view (see) the document which was granted only to specific persons within a company is canceled. Further, document data may be recorded in, for example, the collaborative edit service 216.

### (Configuration of Additional Information Table 214)

FIG. 4 is a diagram illustrating an example of the additional information table 214. The additional information table 214 is a table in which additional information to an edit and location information of the edit identifying a location of the edit in the document (hereinafter also referred to as an “edit location”)are recorded in association with each other. The additional information table 214 may have, for example, a “document ID” column, an “edit location ID” column, an “edit user” column, an “edit content” column, and an “edit reason” column.

The document ID corresponds to the document ID of the document information table 212. In the “edit location ID” column, location information of the edit is recorded, which may include numeral and alphabets. In the “edit content” column, content of the edit is recorded. In the “edit reason” column, a reason for the edit input by an operator are recorded. The edit reason is an example of the additional information.

### (Screen Information 215)

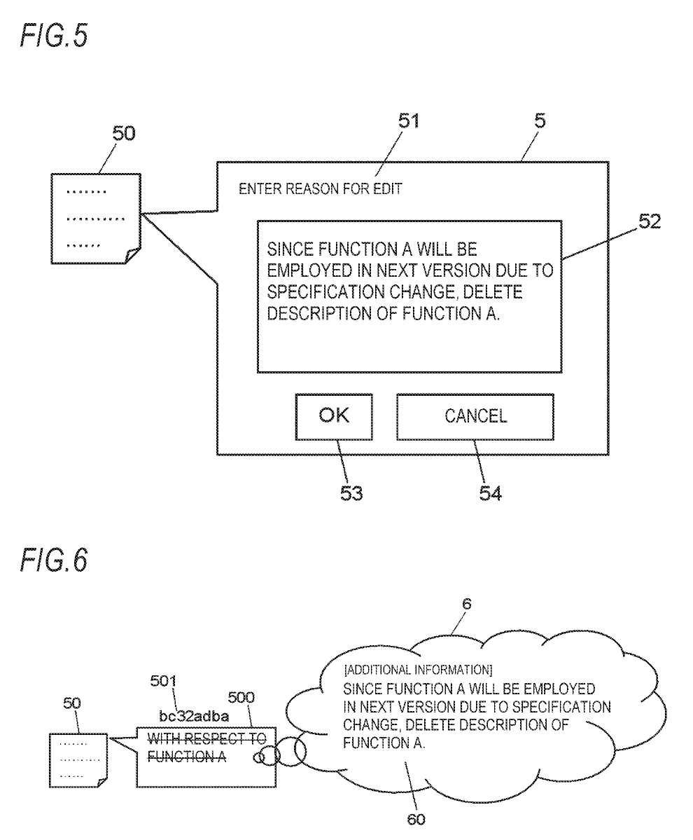

The screen information 215 is information on various screens that are controlled by the display controller 203 (which will be described later) to be displayed on a display 33 of the terminal device 3. The screen information 215 will be described with reference to FIGS. 5 and 6. FIG. 5 is a diagram illustrating an example of an additional information input screen 5.

As illustrated in FIG. 5, for example, a message 51, an input field 52, an OK button 53, and a cancel button 54 are provided on the additional information input screen 5. The message 51 prompts the first operator (editor) to input a reason for the edit. The first operator inputs a reason for the edit to the input field 52. Upon press of the OK button 53 (even if nothing is input to the input field 52), the reason for the edit input to the input field 52 is transmitted. Upon press of the cancel button 54, the input of the reason for the edit is stopped. The reason for the edit is an example of the additional information. The additional information may be input by voice or by text.

As illustrated in FIG. 5, the additional information input screen 5 may have a shape of a speech balloon a part of which protrudes toward the outside. In addition, the speech balloon may be arranged and displayed so as to indicate the edit location in the document 50.

FIG. 6 is a diagram illustrating an example of a pop-up window. As illustrated in FIG. 6, additional information 60 is displayed on the pop-up window 6. Further, the pop-up window 6 is arranged and displayed so as to indicate an edit content display area 500 in which edit content is displayed. Further, the edit content display area 500 may be arranged and displayed so as to indicate a location in the document 50 corresponding to the edit location. Further, an edit location ID 501 may be displayed together.

The pop-up window 6 is displayed on the display 33 of the terminal device 3 in response to, for example, an operation to move a mouse cursor in the document 50.

The collaborative edit service 216 is an application that allows plural operators to collaboratively edit the same document. The collaborative edit service 216 includes a program such as a document creation program, a graphic creation program, or a spreadsheet program.

Next, the respective units of the controller 20 will be described. The connection state detector 200 detects whether each terminal device 3 is connected to the document management apparatus 2. Further, the connection state detector 200 records a detection result, that is, the connection state of each terminal device 3 in the terminal device table 211 of the storage 21.

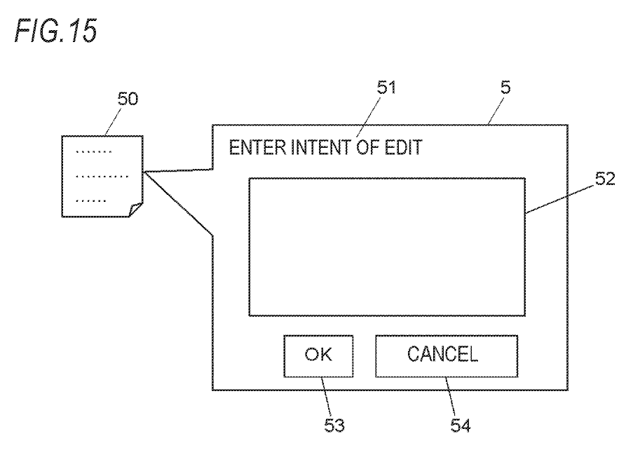

The receiver 201 receives various signals and information transmitted from the terminal devices 3. One example of a signal or information received by the receiver 201 may be an operation signal indicating an operation performed on the additional information input screen 5 (see FIG. 15).

The display controller 203 also performs control so as to display various screens (recorded in the screen information 215 of the storage 21) on a display 33A of the first terminal device 3A while the document is edited.

Specifically, the display controller 203 controls the terminal device 3 to display the additional information input screen 5 on the display 33 of the terminal device 3 according to a predetermined condition. The additional information input screen 5 allows the editor to provide the additional information. The additional information input screen 5 is an example of an input unit.

Examples of “a predetermined condition” include:
(A) A condition related to the number of terminal devices 3 connected to the document management apparatus 2.

(A-1) The number of connected terminal devices 3 is equal to or less than a certain number.

(A-2) The number of connected terminal devices 3 decreases.
(B) A condition related to an attribute of the document which is collaboratively edited.

(B-1) The document has a specific attribute or an attribute of the document satisfies a specific condition.
(C) A condition related to an attribute of an operator who collaboratively edits the document.

(C-1) No terminal device operated by an operator who belongs to a specific department is connected.

(C-2) The first operator (editor) has a pointing-out frequency equal to or higher than a threshold, wherein the pointing-out frequency indicates the number of times things regarding the edit of the document were pointed out to the first operator (editor concerned) in the past.

The above described conditions are mere examples. The predetermined condition is not limited to the above examples. For example, the “terminal devices 3” in the above conditions may be replaced by “terminal devices 3B.” Further, all of the above described conditions are not necessarily satisfied. At least any one of the above described conditions may be satisfied.

The display controller 203 refers to the terminal device table 211 and the document information table 212 and determines whether the connection state of the terminal devices 3, the document, or the operators satisfy any one of the conditions.

The display controller 203 also performs control so as to display the additional information input screen 5 on the display 33 of the terminal device 3. When the display controller 203 determines that the connection state of the terminal devices 3, the document, or the operator satisfies any one of the above described conditions, by transmitting to the terminal device 3 display instruction information that instructs to display the additional information input screen 5.

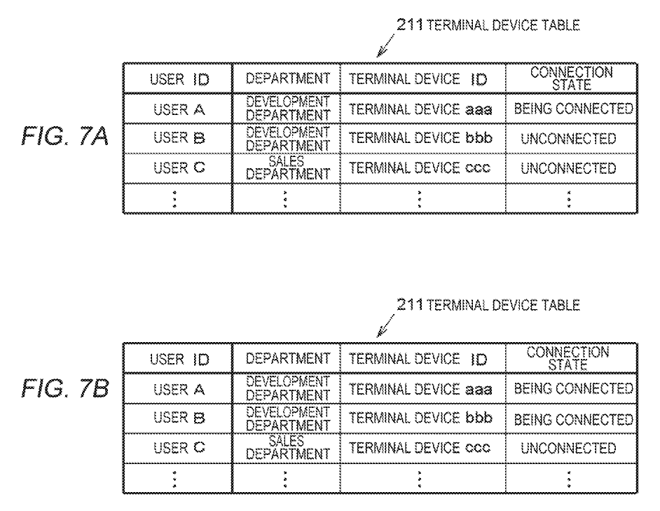

With reference to FIGS. 7A and 7B, details of the determination function of the display controller 203 will be described. FIGS. 7A and 7B are diagrams illustrating an example of the terminal device table 211. Hereinafter, the connection state shown in the terminal device table of FIG. 2A will be referred to as a first connection state. FIG. 7A illustrates an example of the terminal device table 211 for a second connection state. FIG. 7B illustrates an example of the terminal device table 211 for a third connection state.

Specifically, the display controller 203 refers to the connection state of each terminal device 3 recorded in the terminal device table 211 of the storage 21, acquires the number of terminal devices 3 connected to the document management apparatus 2, and determines whether the acquired number satisfies the condition (A-1) or the condition (A-2).

More specifically, for example, when the connection state changes from the first connection state (FIG. 2A) in which the three terminal devices 3 are connected to the document management apparatus 2 to the second connection state (FIG. 7A) in which only, one terminal device 3 is connected to the document management apparatus 2, that is, when the number of terminal devices 3 connected to the document management apparatus 2 decreases, the display controller 203 determines that the connection state satisfies the condition (A-1). Further, in the condition (A-1), the certain number may be, for example, “1”. The certain number is an example of the “predetermined number”.

The display controller 203 refers to the attribute of the document under collaboratively editing, which is recorded in the document information table 212 of the storage 21, acquires the attribute of the document, and determines Whether the attribute of the document satisfies the condition (B-1). As an example, when the publication date of the document is prior to a present time (that is, today) or when the publication date is set to a date (for example, a date immediately after today) which is within the predetermined number of days from the present time, the display controller 203 determines that the document satisfies the condition (B-1).

The display controller 203 refers to the record of the terminal device table 211 of the storage 21, acquires the attributes of the operators corresponding to the terminal devices 3 connected to the document management apparatus 2, and determines whether the acquired attributes satisfy the condition (C-1).

For example, as illustrated in FIG. 7B, when no terminal device 3 operated by an operator who belongs to a specific department (a “sales department” in the example of FIG. 713) is connected, the display controller 203 determines that the condition (C-1) is satisfied. In this case, as in the example illustrated in FIG. 7B, the editor and the collaborator may belong to the same department or belong to different departments. Further, the condition (C-2) will be described later (see Modification 1).

When the operator selects the edit location in the document, the display controller 203 refers to the additional information table 214 (which will be described later) and performs control so as to display the additional information associated with the edit location.

When the additional information is not input to the additional information input screen 5, the edit controller 204 invalidates the edit. The phrase “invalidate the edit” refers to performing control so that content of the edit is not saved in association with, for example, the document data while the edit is discarded and the document is restored to a state before the edit is made.

The phrase “when the additional information is not input to the additional information input screen 5” is, for example, a case Where the OK button 53 is operated while no additional information is input, that is, a case where the receiver 201 receives only an OK operation signal associated with an operation of the OK button 53 without receiving additional information or a case where the receiver 201 receives a cancel operation signal associated with an operation of the cancel button 54.

The edit controller 204 specifies the first terminal device 3A (that is, the terminal device 3A of the editor) on which the operation to edit the document is being performed from among the plural terminal devices 3 based on the operation signal transmitted from the terminal device 3.

The additional information management unit 205 stores the additional information input to the additional information input screen 5 and the location information of the edit in the storage 21 in association with each other.

### (Configuration of Terminal Device 3)

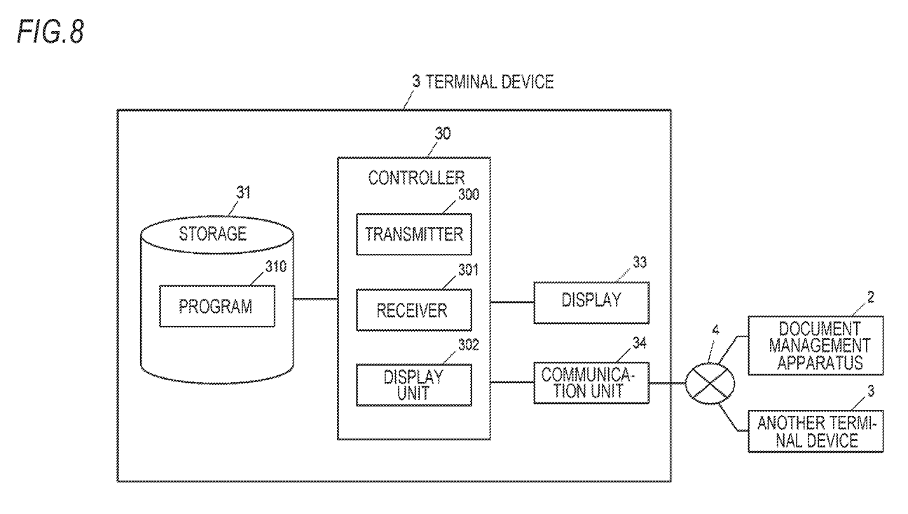

FIG. 8 is a diagram illustrating an example of a control system of the terminal device 3. As illustrated in FIG. 8, the terminal device 3 includes a controller 30, a storage 31 that stores various data, the display 33 implemented by, for example, a liquid crystal display, and a communication unit 34 which communicates with the document management apparatus 2 via the network 4.

The controller 30 includes, for example, a central processing unit (CPU) and an interface. The CPU operates according to a program 310 stored in the storage 31 to thereby serve as, for example, a transmitter 300, a receiver 301 and a display unit 302.

The transmitter 300 transmits, for example, various information and various signals to the document management apparatus 2. The receiver 301 receives various information and various signals transmitted from the document management apparatus 2. The display unit 302 displays various screens on the display 33 based on the display instruction information transmitted from the document management apparatus 2.

The storage 31 is implemented by a read only memory (ROM), a random access memory (RAM), or a hard disk. The storage 31 stores various data such as the program 310.

### (Operation of First Exemplary Embodiment)

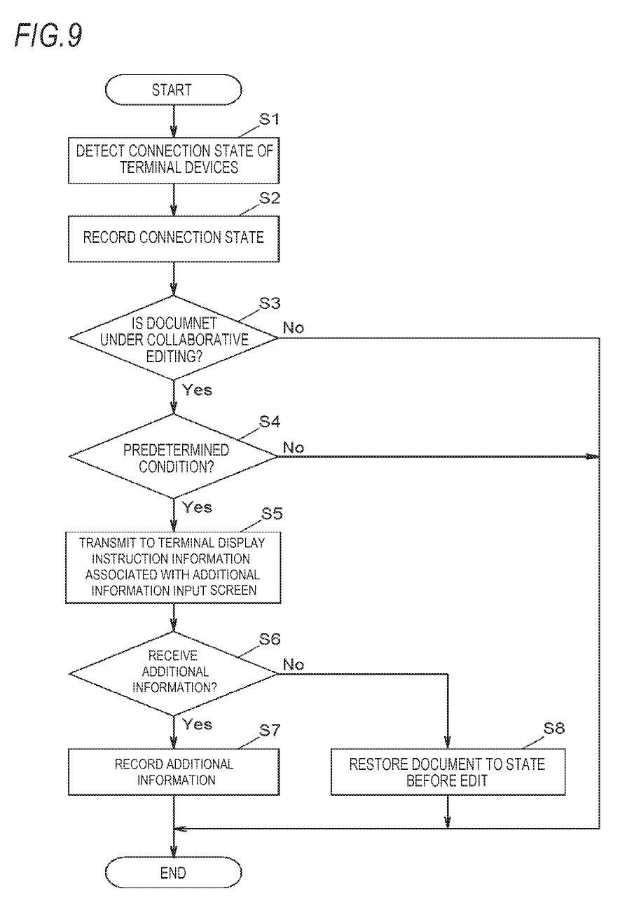

Next, an example of the operation of the document management system 1 will be described with reference to FIG. 9. FIG. 9 is a flowchart illustrating an example of an operation of the document management apparatus 2. In the following description, it is assumed that only operations associated with the document management apparatus 2 will be described and illustrated in FIG. 9 and that step numbers each including a letter of “S” and a numeral are assigned to the operations associated with the document management apparatus 2.

The connection state detector 200 detects the connection state of the terminal devices 3 (S1) and records the detected connection state in the terminal device table 211 of the storage 1 (S2).

When plural terminal devices 3 are connected to the document management apparatus 2, that is. When the document is under collaboratively editing (Yes in S3), according to the predetermined condition (Yes in S4), the display controller 203 transmits the display instruction information associated with the additional information input screen 5 to the first terminal device 3A that is being operated by the editor (S5), to perform control so as to display the additional information input screen 5 on the display 33A of the first terminal device 3A.

The receiver 301 of the first terminal device 3A receives the display instruction information associated with the additional information input screen 5 and transmitted from the document management apparatus 2. The display unit 302 of the first terminal device 3A displays the additional information input screen 5 on the display 33A. When the additional information is input by the first operator (editor) to the additional information input screen 5 displayed on the display 33A, the transmitter 300 of the first terminal device 3A transmits the input additional information to the document management apparatus 2.

The receiver 201 of the document management apparatus 2 receives the additional information transmitted from the first terminal device 3A (S6). When the receiver 201 of the document management apparatus 2 receives the additional information (Yes in S6), the additional information management unit 205 records the additional information in the additional information table 214 of the storage 21 in association with location information of the edit (S7).

When the receiver 201 of the document management apparatus 2 receives no additional information, that is, when the receiver 201 of the document management apparatus 2 receives only the OK operation signal with no additional information provided or when the receiver 201 of the document management apparatus 2 receives the cancel operation signal (No in S6), the edit controller 204 restores the document to the state before the edit (SS).

### Modification 1

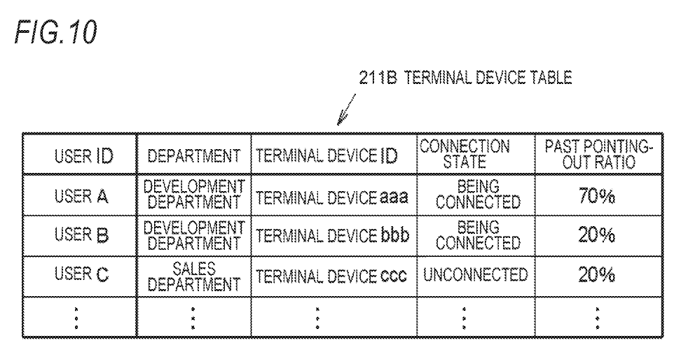

FIG. 10 is a diagram illustrating a modification of the terminal device table. In a terminal device table 211B according to the modification, a “past pointing-out ratio” column is further provided in addition to the columns of the terminal device table 211 described in the exemplary embodiment. In the “past pointing-out ratio” column, a ratio indicating how often things regarding a document are pointed out to the first operator in the past, for example, during an approval process of the document is recorded. This information may be set in advance or may be updated over the approval process. The past pointing-out ratio is an example of the attribute of the operator.

The display controller 203 may refer to the terminal device table 211B, and when the past pointing-out ratio is equal to or larger than a predetermined value, the display controller 203 may perform control so as to display the additional information input screen 5 on the terminal device 3 of the corresponding operator.

### Modification 2

The display controller 203 may perform control so as to display edit history of an edit to a document on the display 33 of the terminal device 3 according to the connection state of the terminal devices 3. Specifically, the display controller 203 may perform control so as to only display edit history of an edit which was made while the number of terminal devices 3 connected to the document management apparatus 2 is less than a predetermined number, on the display 33 of the terminal device 3.

In other words, the display controller 203 may control the terminal device 3 not to display content of an edit that has been made under a condition where the number of terminal devices 3 connected to the document management system is equal to or more larger than the predetermined number.

### Second Exemplary Embodiment

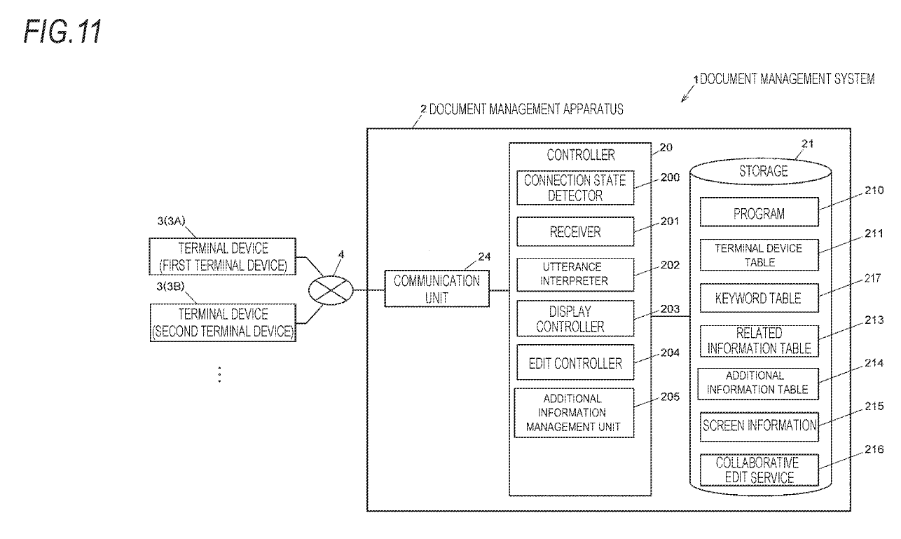

FIG. 11 is a diagram illustrating an example of the configuration of a document management system according to a second exemplary embodiment of the present disclosure. The document management system I includes a document management apparatus 2, plural terminal devices 3, and a network 4. The network 4 allows the document management apparatus 2 and the plural terminal devices 3 to communicate with each other. The document management apparatus 2 is, for example, a server apparatus (may be a cloud server apparatus).

As the terminal device 3, for example, a personal computer, a tablet terminal, or a multifunctional mobile phone (smart phone) may be used. Alternatively, the terminal device 3 may be a web browser.

The terminal devices 3 may be used to, for example, edit a document on the document management apparatus 2. Persons who operate the terminal devices 3 may be collectively referred to as operators “users”). The operators include a first operator (also referred to as an “editor”) who is editing a document from one of the plural terminal devices 3 and a second operator (also referred to as an “utterer”) who makes an utterance at another one of the plural terminal devices 3. The operators may be participants in a discussion where a document managed by the document management apparatus 2 is edited.

In the following description, when it is necessary to distinguish the terminal device 3 operated by the first operator (editor) who is editing a document and the other terminal device(s) 3, the terminal device 3 operated by the editor may be referred to as a “first terminal device 3A” and the other terminal device(s) 3 may be referred to as “second terminal device(s) 3B”. The plural terminal devices may include one or more second terminal devices 3B.

The network 4 may be, for example, a local area network (LAN), a wide area network (WAN), the Internet, or Intranet and may be a wired network or a wireless network.

### (Configuration of Document Management Apparatus 2)

The document management apparatus 2 includes a controller 20, a storage 21 that stores various data, and a communication unit 24 that communicates with the terminal devices 3 via the network 4.

The controller 20 includes a central processing unit (CPU), an interface, and the like. The CPU operates in accordance with a program 210 stored in the storage 21, to thereby function as, for example, a connection state detector 200, a receiver 201, an utterance interpreter 202, a display controller 203, an edit controller 204, and an additional information management unit 205. The edit controller 204 is an example of an edit unit. Details of each of the units 200 to 205 will be described later.

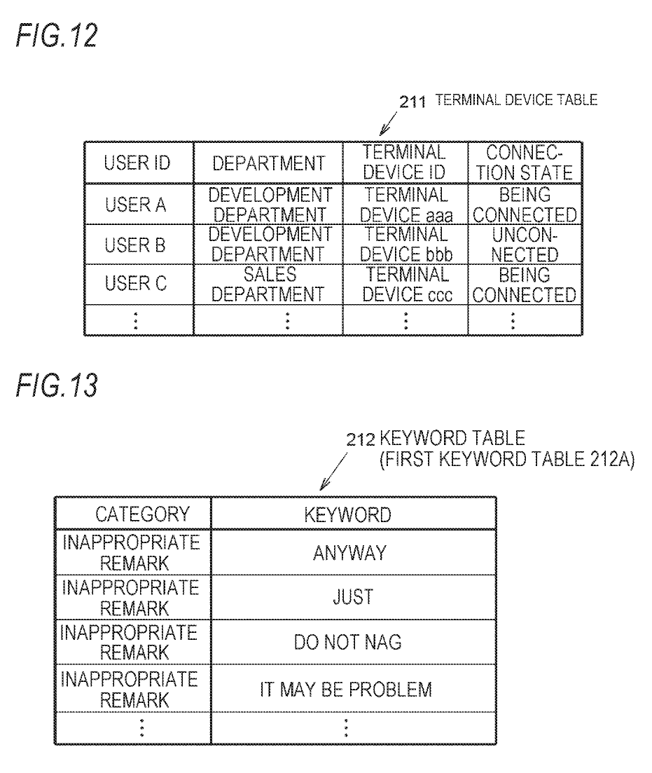

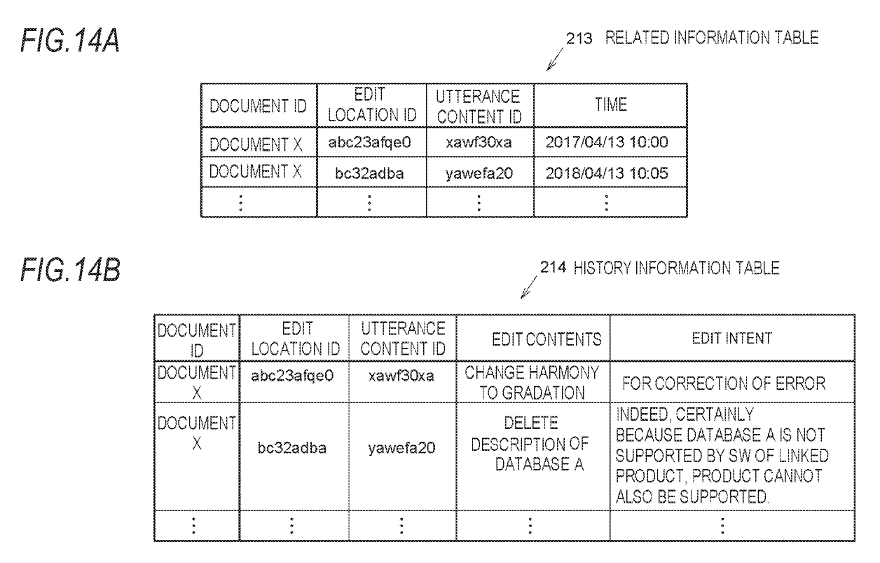

The storage 21 is implemented by a read only memory (ROM), a random access memory (RAM), or a hard disk and stores various data such as the program 210, a terminal device table 211 (see FIG. 12), a keyword table 217 (see FIG. 13), a related information table 213 (see FIG. 14A), an additional information table 214 (see FIG. 14B), screen information 215, and a collaborative edit service 216. The storage 21 is an example of a storage. Tables 211 to 214 and the screen information 215 will be described later.

The collaborative edit service 216 is an application that allows plural operators to collaboratively edit the same document. The collaborative edit service 216 includes a program such as a document creation program, a graphic creation program, or a spreadsheet program. The collaborative edit service 216 includes the document to be edited.

Next, the respective units of the controller 20 will be described. The connection state detector 200 detects whether each terminal device 3 is connected to the document management apparatus 2. Further, the connection state detector 200 records a detection result in the terminal device table 211 of the storage 21. It should be noted that in this specification, when information is written into a table, the term “record” is used and that when information is written into the storage 21, the term “store” is used.

Here, the phrase “the terminal device 3 is connected to the document management apparatus 2” refers to a state in which a document is editable on the document management apparatus 2 by operating the terminal device 3. The term “connected (connect, connection)” includes, for example, a state in which the collaborative edit service 216 stored in the document management apparatus 2 is available to the terminal device 3.

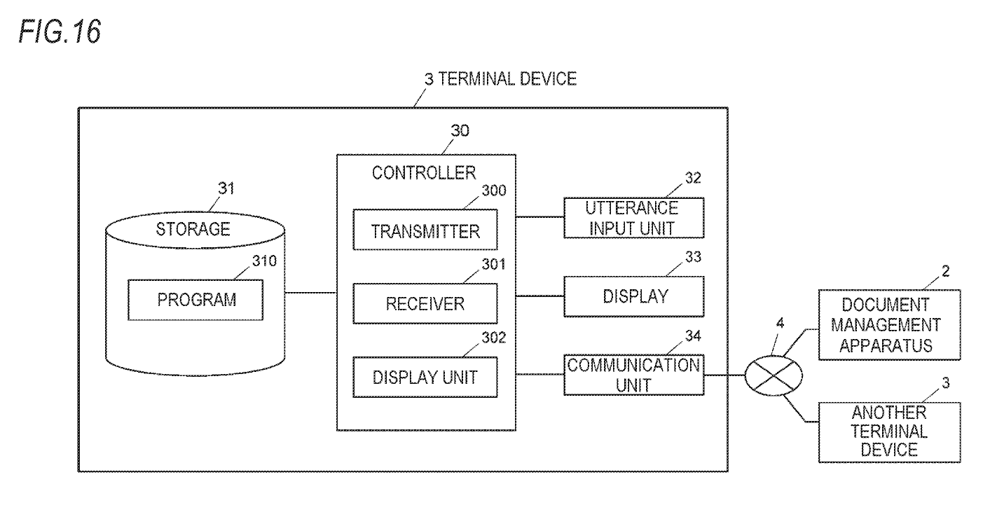

The receiver 201 receives various signals and information transmitted from the terminal devices 3. Examples of a signal or information received by the receiver 201 include data of an utterance input to an utterance input unit 32 (see FIG. 16) of the terminal device 3 and an operation signal indicating an operation performed on the additional information input screen 5 (see FIG. 15). The utterance information includes, for example, voice information (sound waveform information) input from a microphone or text information input from a keyboard.

The utterance interpreter 202 interprets the content of the utterance from the utterance information received by the receiver 201 while the document is collaboratively edited. The phrase “while a document is collaboratively edited” refers to a state in which plural operators may collaboratively edit the same document. In other words, the phrase “while a document is collaboratively edited” refers to that plural terminal devices 3 are connected to the document management apparatus 2. Further, the phrase “while a document is collaboratively edited” only requires a state in which it is possible to edit the document (for example, a state in which it is possible to view the document from the plural terminal devices 3). It should be noted that the phrase “while a document is collaboratively edited” is not limited to a state where an edit is being made to the document by any one of the operators.

Specifically, the utterance interpreter 202 refers to the terminal device table 211 and determines whether the plural terminal devices 3 are connected to the document management apparatus 2, to thereby determine whether the document is in a state of being collaboratively edited. Further, hereinafter, a state where a document is being collaboratively edited may be referred to as “under collaborative editing”.

The utterance interpreter 202 analyzes the utterance information using, for example, a morphemic analysis or dictionary information to recognize the content of the utterance. In addition, when the utterance information is sound waveform information, the utterance interpreter 202 analyzes the sound waveform information to specify information about a language and interprets the content of the utterance using the morphemic analysis and the dictionary information.

The display controller 203 performs control so as to display the additional information input screen 5 on the display 33 of the terminal device 3 according to a predetermined condition. The additional information input screen 5 allows the operator (editor) to provide the additional information from the terminal 3. The additional information input screen 5 is an example of an input unit.

For example, the display controller 203 may control the terminal device 3 to display the additional information input screen 5 on the display 33 of the terminal device in a case where an utterance is made at the terminal device 3. More specifically, the display controller 203 may control the terminal device 3 to display the additional information input screen 5 on the display 33 of the terminal device in a case where a specific word recorded in the keyword table 217 is included in the content of the utterance interpreted by the utterance interpreter 202. The display controller 203 transmits display instruction information to instruct to display the additional information input screen 5, to the terminal device 3 to thereby perform control the terminal device 3 to display the additional information input screen 5 on the display 33 of the terminal device 3.

The display controller 203 also performs control so as to display the additional information. When the operator selects a location (hereinafter, also referred to as a “location of edit” or simply referred to as an “edit location”) where the edit is performed in the document, the display controller 203 refers to the related information table 213 and the additional information table 214 (which will be described later) and performs control so as to display the additional information associated with the selected edit location.

The edit controller 204 invalidates the edit in a case where no additional information is provided from the additional information input screen 5. The phrase “invalidate the edit” refers to performing control so that content of the edit is not saved in association with, for example, the document data. It also refers to performing control so that the edit is discarded and the document is restored to a state before the edit is made. The phrase “when no additional information is provided from the additional information input screen 5” is, for example, a case where an OK button 53 is selected with no additional information provided, that is, a case where the receiver 201 receives no additional information but only an OK operation signal indicating selection of the OK button 53 from the terminal device 3 or a case where the receiver 201 receives a cancel operation signal indicating selection of a cancel button 54 from the terminal device 3.

The edit controller 204 also identifies the first terminal device 3A (that is, the terminal device 3A of the editor) from which an edit to the document is being made among the plural terminal devices 3 based on the operation signal transmitted from the terminal device 3.

The additional information management unit 205 stores the additional information provided from the additional information input screen 5 and location information of the edit indicating a location of the edit in the document in association with each other in the storage 21. For example, the location of the edit may be indicated by a page number, a column number, a line number, or a combination thereof The location of the edit may alternatively be indicated by a specific part of the content of the document the edit relates to. Examples of a specific part of the content of the document the edit relates to include a paragraph that includes the edit and a chapter that includes the edit.

Specifically, the additional information management unit 205 records information for locating the edit as the location information of the edit and information for identifying the content of the utterance in the related information table 213 of the storage 21 in association with each other. Also, the additional information management unit 205 records the information for identifying the content of the utterance and the additional information in the additional information table 214 of the storage 21 in association with each other.

### (Configuration of Terminal Device Table 211)

FIG. 12 is a diagram illustrating an example of the terminal device table 211. The terminal device table 211 may have, for example, a “user ID” column, a “department” column, a “terminal device ID” column, and a “connection state” column.

In the “user ID” column, identification information of the operator who operates the terminal device 3 is recorded. In the “department” column, a name of a department to which the operator belongs is recorded. Other attributes of the operator than the department may also be recorded in association with the user ID of the operator. Examples of an attribute include an employee number, a duty, a position, and an authority of an operation.

In the “terminal device ID” column, identification information of the terminal device 3 operated by the operator is recorded. Instead of the ID, for example, an IP address may be recorded. In the “connection state” column, whether the terminal device 3 is connected to the document management apparatus 2 or not is recorded. For example, “connected” indicates that the terminal device 3 is connected to the document management apparatus 2 and “unconnected” indicates that the terminal device 3 is not connected to the document management apparatus 2.

### (Configuration of Keyword Table 217)

FIG. 13 is a diagram illustrating an example of a keyword table. As illustrated in FIG. 13, in the keyword table 217, a “category” column and a “keyword” column are provided. In the “keyword” column, a specific word is recorded, which the display controller 203 uses when determining whether to record the additional information. In the “category” column, a group name for classifying the specific word is recorded.

Examples of the specific word include words having negative meanings such as “anyway” and “never mind”. Further, the specific word is not only fixedly recorded but also dynamically recorded based on, for example, frequencies of words spoken within a specific time. Further, for example, specific words may be learnt in advance by using a learning function such as deep learning.

### (Configuration of Related Information Table 213)

FIG. 14A is a diagram illustrating an example of the related information table. The related information table 213 is a table in which the location information of the edit and the information for identifying the content of an utterance are recorded in association with each other. The related information table 213 may have, for example, a “document ID” column, an “edit location ID” column, an “utterance content ID” column, and a “time” column.

In the “document ID” column, identification information (hereinafter, also referred to as “ID”) of a document the edit relates to is recorded. In the “edit location ID” column, the If) of the edit location is recorded. In the “utterance content ID” column, the ID of the content of the utterance is recorded. In the “time” column, date and time at which the edit is performed is recorded, for example, in the form of “yyyy/mm/dd hh:mm”. IDs may include numerals and alphabets.

### (Configuration of Additional Information Table 214)

FIG. 14B is a diagram illustrating an example of the additional information table. The additional information table 214 is a table in which information for identifying the content of the utterance and the additional information are recorded in association with each other. The additional information table 214 may have, for example, a “document ID” column, an “edit location ID” column, an “utterance content ID” column, an “edit content” column, and an “edit intent” column are provided.

The document ID, the edit location ID, and the utterance content ID correspond to the document ID, the edit location ID, and the utterance content ID of the related information table 213, respectively. In the “edit content” column, content of the edit is recorded. In the “edit intent” column, an intention of the edit input by the operator is recorded. The edit intent is an example of the additional information.

### (Screen Information 215)

The screen information 215 is information on various screens that are controlled by the display controller 203 (which will be described later) to be displayed on the display 33 of the terminal device 3. The screen information 215 will be described with reference to FIG. 15. FIG. 15 is a diagram illustrating an example of the additional information input screen 5.

As illustrated in FIG. 15, for example, a message 51, an input field 52, the OK button 53, and the cancel button 54 are provided on the additional information input screen 5. The message 51 prompts the first operator (editor) to input an intent of the edit. The first operator inputs an intent of the edit to the input field 52. Upon press of the OK button 53 (even if nothing is input to the input field 52), the intent of the edit input to the input field 52 is transmitted. Upon press of the cancel button 54, the input of the intent of the edit is stopped. The intent of the edit is an example of the additional information. The additional information may be input by voice or by text.

As illustrated in FIG. 15, the additional information input screen 5 may have a shape of a speech balloon a part of which protrudes toward the outside. In addition, the speech balloon may be arranged and displayed so as to indicate the edit location in a document 50.

### (Configuration of Terminal Device 3)

FIG. 16 is a diagram illustrating an example of a control system of the terminal device 3. As illustrated, in FIG. 16, the terminal device 3 includes a controller 30, a storage 31 that stores various data, the utterance input unit 32 through which an utterance is input, the display 33 implemented by a liquid crystal display, and a communication unit 34 that communicates with the document management apparatus 2 via the network 4.

The controller 30 includes, for example, a central processing unit (CPU) and an interface. The CPU operates according to a program 310 stored in the storage 31 to thereby serve as, for example, a transmitter 300, a receiver 301 and a display unit 302.

The transmitter 300 transmits various information such as utterance information and various signals such as an operation signal to the document management apparatus 2. The receiver 301 receives various information and various signals transmitted from the document management apparatus 2. The display unit 302 displays various screens on the display 33 based on the display instruction information transmitted from the document management apparatus 2.

The storage 31 is implemented by a read only memory (ROM), a random access memory (RAM), or a hard disk. The storage 31 stores various data such as the program 310. The utterance input unit 32 includes, for example, a voice detector (for example, a microphone) and an operation unit. The voice detector is configured to detect voice of the operator and convert, the detected voice into sound waveform information. The operation unit includes, for example, a keyboard using which the operator inputs information.

### (Operation of Second Exemplary Embodiment)

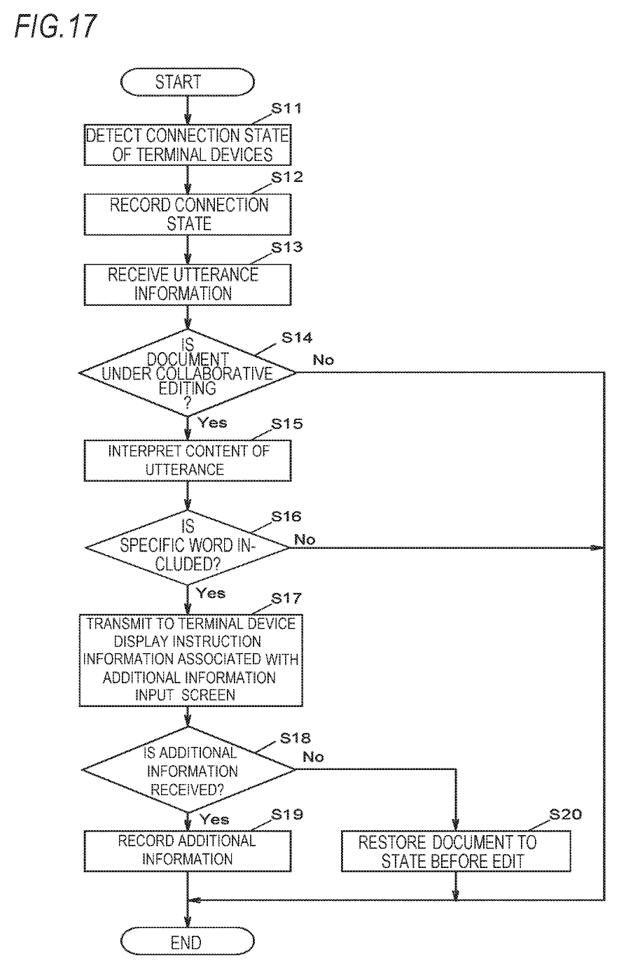

Next, an example of the operation of the document management system 1 will be described with reference to FIG. l7. FIG. 17 is a flowchart illustrating an example of the operation of the document management apparatus 2 according to the second exemplary embodiment. In the following description, only operations associated with the document management apparatus 2 will be described and illustrated in FIG. 17 and that step numbers each including a letter of “S” and a numeral are assigned to the operations associated with the document management apparatus 2.

The connection state detector 200 detects the connection state of the terminal devices 3 (S11) and records the detected connection state in the terminal device table 211 of the storage 21 (S12)

When the second operator (utterer) inputs an utterance to the utterance input unit 32B of the second terminal device 3B, a transmitter 300B of the first second device 3B transmits utterance information to the document management apparatus 2. The receiver 201 of the document management apparatus 2 receives the utterance information transmitted from the second terminal device 3B (S13).

When plural terminal devices 3 are connected to the document management apparatus 2, that is, when the document is under collaboratively editing (Yes in S 14), the utterance interpreter 202 interprets content of the utterance from the utterance information received by the receiver 201 (S15). Next, when a specific word recorded in the keyword table 217 is included in the content of the utterance (Yes in S16), the display controller 203 transmits display instruction information associated with the additional information input screen 5 to the first terminal device 3A operated by the editor (S17) to perform control so as to display the additional information input screen 5 on the display 334 of the first terminal device 3A.

The receiver 301 of the first terminal device 3A receives the display instruction information associated with the additional information input screen 5 and transmitted from the document management apparatus 2. The display unit 302 of the first terminal device 3A displays the additional information input screen 5 on the display 33A. When the additional information is input by the first operator (editor) to the additional information input screen 5 displayed on the display 33A, the transmitter 300 of the first terminal device 3A transmits the input additional information to the document management apparatus 2.

The receiver 201 of the document management apparatus 2 receives the additional information transmitted from the first terminal device 34 (S18). When the receiver 201 of the document management apparatus 2 receives the additional information (Yes in S18), the additional information management unit 205 records the additional information and the information for identifying the edit location in the related information table 213 and the additional information table 214 of the storage 21, in association with each other (S19).

When the receiver 201 of the document management apparatus 2 does not receive the additional information, that is, when the receiver 201 of the document management apparatus 2 receives only the OK operation signal without receiving the additional information or when the receiver 201 of the document management apparatus 2 receives the cancel operation signal (No in S18), the edit controller 204 restores the document to the state before the edit (S20).

### Modification 3

The display unit 302 of the terminal device 3 may display, for example, a pop-up window on the display 33. The pop-up window is stored in, for example, the storage 21 as screen information 215.

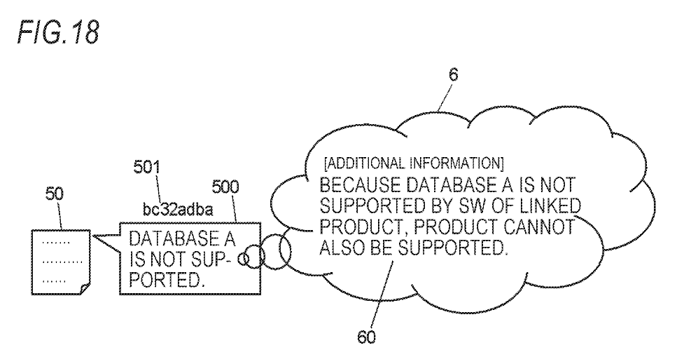

FIG. 18 is a diagram illustrating an example of the pop-up window. As illustrated in FIG. 18, the additional information 60 is displayed on the pop-up window 6. Further, the pop-up window 6 is arranged and displayed so as to indicate an edit content display area 500 in which edit content is displayed. Further, the edit content display area 500 may be arranged and displayed so as to indicate a location in the document 50 corresponding to the edit location. Further, an edit location ID 501 may be displayed together.

Specifically, for example, according to an operation to move a mouse cursor in the document 50, the display controller 203 transmits to the terminal device 3 display instruction information to instruct to display the additional information on the display 33 of the terminal device 3, to thereby display the pop-up window on the display 33.

### Third Exemplary Embodiment

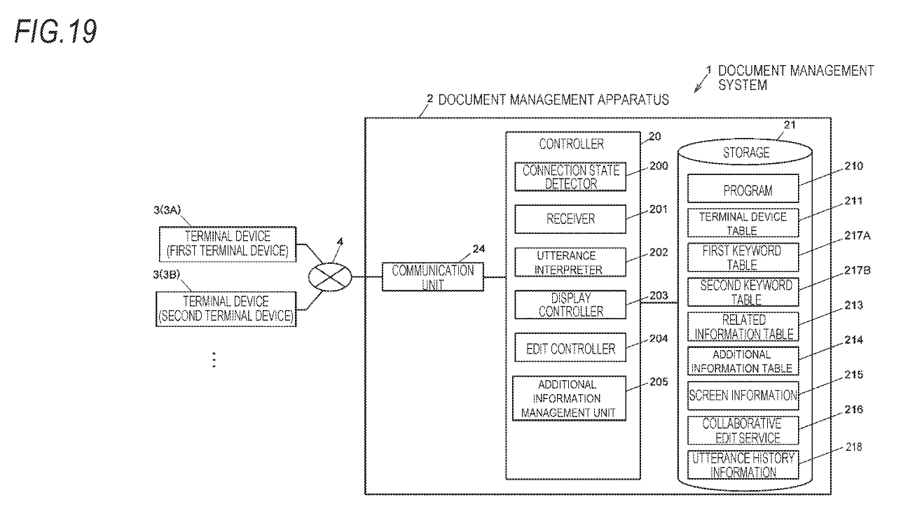

FIG. 19 is a block diagram illustrating an example of a control system of a document management system 1 according to a third exemplary embodiment of the present disclosure. In the second exemplary embodiment, the additional information input by the editor is recorded. The third exemplary embodiment is different from the second exemplary embodiment in that the third exemplary embodiment has a function of automatically recording the additional information based on the utterance information provided by a speaker. Hereinafter, the same configuration and function as those of the second exemplary embodiment will be denoted by the same reference numerals, the description thereof will be omitted, and the description of the third exemplary embodiment will be focused on differences from the second exemplary embodiment.

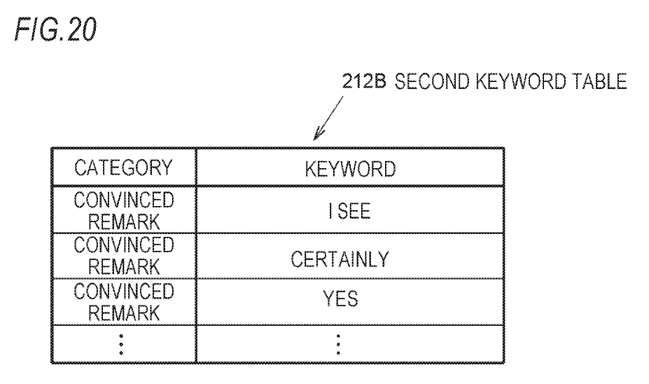

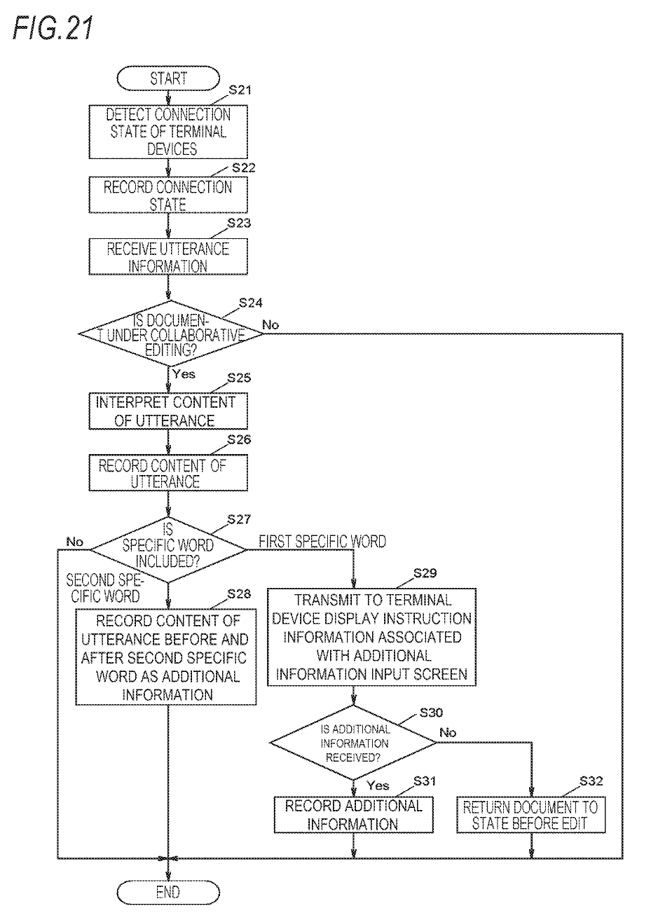

The keyword table 217 described in the second exemplary embodiment will be referred to as a first keyword table 217A in the third exemplary embodiment. In addition to the information described in the second exemplary embodiment, the storage 21 further stores a second keyword table 217B and utterance history information 218 (see FIG. 20). The utterance history information 218 is information in which content of utterance is recorded in association with an utterance order (or a time when the utterance is made or a time when the utterance information is received).

### (Configuration of Second Keyword Table 217B)

FIG. 20 is a diagram illustrating an example of the second keyword table 217B. Hereafter, the first keyword table 217A and the second keyword table 217B may be collectively referred to as a “keyword table 217”.

Here, the specific word recorded in the “keyword” column of the first keyword table 217A will be referred to as a first specific word. As illustrated in FIG. 20, in a “keyword” column of the second keyword table 217B, a second specific word is recorded which the additional information management unit 205 uses to make a determination (which will be described later).

Examples of the second specific word include words having positive meanings such as “certainly” and “indeed”. Further, the second specific word is not only fixedly recorded but also dynamically recorded based on, for example, frequencies of words spoken within a specific time. Further, for example, second specific words may be learnt in advance by using a learning function such as deep learning.

The utterance interpreter 202 has a function of interpreting content of an utterance that is made while the document is collaboratively edited and storing the content of the utterance in the storage 21, in addition to the function described in the second exemplary embodiment.

In addition to the function described in the second exemplary embodiment, the additional information management unit 205 has a function to record, in the additional information table 214 of the storage 21, content of the utterance interpreted by the utterance interpreter 202 as the additional information in a case where the second specific word recorded in the second keyword table 217B is included in the of the utterance interpreted by the utterance interpreter 202. More specifically, the additional information management unit 205 records what was stated before and/or after the second specific word in the additional information table 214 of the storage 21 as the additional information.

Here, “what was stated before and/or after the second specific word” may refer to a specific number of morphemes before and/or after the second specific word. “What was stated before and/or after the second specific word” may be specified in terms of, for example, (i) positional relationship or (ii) temporal relationship. Examples of the former include a sentence before and/or after the second specific word and a predetermined number of words before and/or after the second specific word. Examples of the latter include what was stated in a predetermined timeframe up to the second specific word or what was stated in a predetermined timeframe from the second specific word.

Specifically, when the second specific word recorded in the second keyword table 217B is included in the the utterance interpreted by the utterance interpreter 202, the additional information management unit 205 extracts what was stated before and/or after the second specific word from the utterance history information 218 stored in the storage 21 and records the extracted content as the additional information.

In the “additional information” column of the additional information table 214. The additional information automatically extracted by the additional information management unit 205 is recorded (see the example of the second row of FIG. 14B).

### (Operation of Third Exemplary Embodiment)

Next, an example of the operation of the document management system 1 will be described with reference to FIG. 21. FIG. 21 is a flowchart illustrating an example of an operation of the document management apparatus 2 according to the third exemplary embodiment. The operation associated with the terminal device 3 is the same as that described in the second exemplary embodiment. Therefore, in the following description, the description of the operation associated with the terminal device 3 will be omitted.

Steps S21 to S25 operate in a similar manner to steps S11 to S15 of the operation of the second exemplary embodiment. That is, the connection state detector 200 detects the connection state of the terminal devices 3 (S21) and records the connection state in the terminal device table 211 (S22). The receiver 201 of the document management apparatus 2 receives the utterance information transmitted from the second terminal device 3B (S23). When the document is under collaborative editing (Yes in S24), the utterance interpreter 202 interprets the content of the utterance from the utterance information received by the receiver 201 (S25).

The utterance interpreter 202 records the interpreted content of the utterance in the utterance history information 218 of the storage 21 (S26). When the second specific word recorded in the second keyword table 217B is included in the utterance (S27: second specific word), the additional information management unit 205 extracts what was stated before and/or after the second specific word from the utterance history information 218 and records the extracted content of the utterance in the additional information table 214 of the storage 21 as the additional information (S28).

When the first specific word recorded in the first keyword table 217A is included in the the utterance (S27: first specific word), the same operation is performed as steps 517 to S20 described in the second exemplary embodiment. That is, the display controller 203 transmits the display instruction information associated with the additional information input screen 5 to the first terminal device 3A (S29) and performs control so as to display the additional information input screen 5 on the display 334 of the first terminal device 3A. The receiver 201 of the document management apparatus 2 receives the additional information transmitted from the first terminal device 3A (S30). The additional information management unit 205 records the additional information and the information for identifying the edit location in the related information table 213 and the additional information table 214 of the storage 21 in association with each other (S31).

When the receiver 201 of the document management apparatus 2 does not receive the additional information (No in S30), the edit controller 204 restores the document to the state before the edit (S32).

### Modification 4

The display controller 203 may control the terminal device 3 to display edit history of an edit to a document on the display 33 of the terminal device 3 according to a state of the utterance. For example, the display controller 203 may control the display 33 of the terminal device 3 to only display edit history of an edit made before and/or after an utterance made in a specific state.

More specifically, if the number of precedent utterance prior to the utterance is equal to or larger than a predetermined number or if the utterance is equal to or louder than a predetermined volume, the display controller 203 may transmit to the terminal device 3 the display instruction information to instruct the terminal device 3 to display edit history of an edit made before and/or after the utterance, to thereby control the terminal device 3 to display the edit history on the display 33 of the terminal device 3.

In other words, if the number of precedent utterances prior to the utterance is fewer than the predetermined number or if the utterance is quieter than the predetermined volume, the display controller 03 may not transmit the display instruction information to the terminal device 3 so that the terminal device 3 does not display the edit history on the display 33 of the terminal device 3.

For example, the utterance interpreter 202 may identify the number of precedent utterances by referring to the utterance history information 218 stored in the storage 21. Further, when the utterance information is sound waveform information, the utterance interpreter 202 may analyze the volume of the utterance by analyzing such information as an amplitude of a sound waveform indicated by the sound waveform information.

Content of each edit (content added, deleted, or changed) may be stored in the storage 21 as the edit history in association with a time the edit was made. Any of the units of the controller 20 (for example, the edit controller 204) may identify the edit made before and/or after the utterance by referring to the edit history stored in the storage 21.

Hereinabove, the exemplary embodiments of the present disclosure are described. It should be noted that exemplary embodiments of the present disclosure are not limited to the above described exemplary embodiments and that various modifications may be made within the scope without departing from the spirit of the present invention. For example, in the third exemplary embodiment, the first keyword table 217A and the second keyword table 217B are separately provided. Alternatively, both tables may be integrated to have one keyword table. For another example, the utterance interpreter 202 in the second and third exemplary embodiments may be provided in each terminal device 3.

The determination of whether the connection state of the terminal device 3, the document, or the operator satisfies the any one of the conditions is made by the display controller 203 in the first exemplary embodiment and by the utterance interpreter 202 in the second and third exemplary embodiments. However, another unit such as the connection state detector 200 may make this determination. In the exemplary embodiments, a document to be edited is stored in the storage 21 of the document management apparatus 2. However, exemplary embodiments of the present disclosure are not limited to this example. For example, the document to be edited may be stored in the storage 31 of each terminal device 3. Further, the second and the third exemplary embodiments of the present disclosure are not limited to that the determination as to whether the specific word recorded in the keyword table 217 is included is made by the display controller 203. This determination may be made by another unit such as the utterance interpreter 202.

Part or all of the respective units of the controllers 20 and 30 may be implemented by hardware circuits such as a field programmable gate array (FPGA) or an application specific integrated circuit (ASIC).

It is possible to omit or modify a part of the constituent elements of the exemplary embodiment if the modification does not depart from the spirit of the present invention. In addition, it is possible to add, remove, change, and replace the steps in the flow of the exemplary embodiment if the modification does not depart from the spirit of the present invention. Further, the program used in the exemplary embodiment may be provided while being recorded in a computer readable recording medium such as a CD-ROM. The program used in the exemplary embodiment may be used via the network while being stored in an external server such as a cloud server.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document management apparatus allowing operators of plural terminal devices connected to the document management apparatus to collaboratively edit a document, the document management apparatus comprising:
a display controller configured to display a screen on a display of a first terminal device according to a predetermined condition, the screen allowing an input of additional information to an edit, the edit made from the first terminal device to the document.
wherein the predetermined condition is related to one or more terminal devices connected to the document management apparatus other than the first terminal device.

2. The document management apparatus according to claim 1, wherein the predetermined condition includes the number of the one or more terminal devices connected to the document management apparatus other than the first terminal device.

3. The document management apparatus according to claim 2,
wherein the predetermined condition includes the number of the one or more terminal devices connected to the document management apparatus other than the first terminal device being equal to or less than a predetermined number.

4. The document management apparatus according to claim 2,
wherein the predetermined condition includes decrease in the number of the one or more terminal devices connected to the document management apparatus other than the first terminal device.

5. The document management apparatus according to claim 1, wherein the predetermined condition includes a specific attribute of the document.

6. The document management apparatus according to claim 1, wherein the predetermined condition includes attributes of operators of the plural terminal devices connected to the document management apparatus.

7. The document management apparatus according to claim 1, further comprising:
an edit unit configured to invalidate the edit when no additional information is provided from the screen.

8. The document management apparatus according to claim 1, further comprising:
a storage configured to store the additional information provided from the screen in association with location information of the edit indicating a location of the edit in the document.

9. The document management apparatus according to claim 1,
wherein the display controller is configured not to display edit history of the edit on the display of the first terminal device if the edit is an edit made while the number of terminal devices connected to the document management apparatus is equal to or more than a predetermined number.

10. A document management apparatus according to claim 1, wherein the predetermined condition includes an occurrence of an utterance at a second terminal device connected to the document management apparatus.

11. The document management apparatus according to claim 10,
wherein the predetermined condition includes whether the utterance at the second terminal device includes a first specific word.

12. The document management apparatus according to claim 10, further comprising:
an edit unit configured to invalidate the edit in a case where no additional information is provided from the screen.

13. The document management apparatus according to claim 11, further comprising:
an edit unit configured to invalidate the edit in a case where no additional information is provided from the screen.

14. The document management apparatus according to claim 10, further comprising:
a storage configured to store the additional information provided from the screen in association with location information of the edit indicating a location of the edit in the document.

15. The document management apparatus according to claim 11, further comprising:
a storage configured to store the additional information provided from the screen in association with location information of the edit indicating a location of the edit in the document.

16. The document management apparatus according to claim 14,
wherein the storage is configured to store utterance information of the utterance as the additional information if the utterance includes a second specific word.

17. The document management apparatus according to claim 15,
wherein the storage is configured to store utterance information of the utterance as the additional information if the utterance includes a second specific word.

18. The document management apparatus according to claim 10,
wherein the display controller is further configured to display edit history of the edit on the display of the first terminal device according to a state of the utterance.

19. The document management apparatus according to claim 10, wherein the controller is configured to display the edit on the display of the first terminal device if
(a) the number of precedent utterances at the second terminal device prior to the utterance is larger than a predetermined number, or
(b) the utterance is louder than a predetermined volume.

20. A non-transitory: computer readable medium storing a program that causes a processor of a document management apparatus to execute a document management process, the document management apparatus allowing operators of plural terminal devices connected to the document management apparatus to collaboratively edit a document, the process comprising:
display a screen on a display of the first terminal device according to a predetermined condition, the screen allowing an input of additional information to an edit, the edit made from the first terminal device to the document,
wherein the predetermined condition is related to one or more terminal devices other than the first terminal device.
